(19) United States
(12) Patent Application Publication
(10) Pub. No.: US 2013/0031534 A1
(43) Pub. Date: Jan. 31, 2013

(54) Software Development With Information Describing Preceding Execution Of A Debuggable Program

(71) Applicant: Cary L. Bates, Rochester, MN (US)

(72) Inventor: Cary L. Bates, Rochester, MN (US)

(73) Assignee: INTERNATIONAL BUSINESS MACHINES CORPORATION, Armonk, NY (US)

(21) Appl. No.: 13/191,546

(22) Filed: Jul. 27, 2011

(51) Int. Cl. G06F 9/44; G06F 9/45

(52) U.S. Cl. 717/129

(57) ABSTRACT

Software development with information describing preceding execution of a debuggable program includes receiving, by a debugger from a compiler, a copy of a debuggable program, the debuggable program including one or more phantom breakpoints not encountered during a previous execution of the debuggable program, each phantom breakpoint inserted at a separate line of source code, phantom breakpoints encountered in a previous execution of the debuggable program being removed during the previous execution and not included in the copy of the debuggable program; executing, by the debugger, the copy of the debuggable program; upon each encounter of a breakpoint, determining, by the debugger, whether the encountered breakpoint is a phantom breakpoint; and if the encountered breakpoint is a phantom breakpoint, issuing, by the debugger, a warning indicating a point of straying execution.

### BACKGROUND OF THE INVENTION

1. Field of the Invention

The field of the invention is data processing, or, more specifically, methods, apparatus, and products for software development with information describing preceding execution of a debuggable program.

2. Description of Related Art

Often software debugging is initiated in response to an error in execution of the software outside of a debugging environment. That is, an execution preceding debugging results in one or more errors—a crash, a buffer overflow, an execution freeze, and so on. Once the software is being debugged, it would be useful for a software developer to be reasonably certain that execution in the debugging environment was the same as the execution that preceded debugging. That is, having a controlled testing environment where conditions are the same as the conditions in which the execution resulted in errors is useful, but at present, debugging tools cannot insure that such conditions are the same or inform a user when the conditions are not the same. Said yet another way, software developers may benefit greatly from information describing one or more preceding executions of a debuggable program.

### SUMMARY OF THE INVENTION

Methods, apparatus, and products for software development with information describing preceding execution of a debuggable program are disclosed in this specification. Some aspects of such software development include: receiving, by a debugger from a compiler, a copy of a debuggable program, the debuggable program including one or more phantom breakpoints not encountered during a previous execution of the debuggable program, each phantom breakpoint inserted at a separate line of source code, wherein phantom breakpoints encountered in a previous execution of the debuggable program were removed during the previous execution and not included in the copy of the debuggable program; executing, by the debugger, the copy of the debuggable program; upon each encounter of a breakpoint, determining, by the debugger, whether the encountered breakpoint is a phantom breakpoint; and if the encountered breakpoint is a phantom breakpoint, issuing, by the debugger, a warning indicating a point of straying execution.

Other aspects of such software development include: executing the debuggable program one or more times outside of debugger control, including: encountering, in at least one execution, one or more of the phantom breakpoints, and for each execution: removing, by the breakpoint handling module, each encountered phantom breakpoint, resuming execution, and updating the debuggable program, by the exit handler upon exiting execution, to include only phantom breakpoints not encountered during the execution; and managing phantom breakpoints in the debuggable program.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery forming a system that supports software development with information describing preceding execution of a debuggable program according to embodiments of the present invention.

FIG. 2 sets forth an example GUI presented to a user by a debugger in accordance with embodiments of the present invention.

FIG. 3 sets forth a flow chart illustrating an exemplary method for software development with information describing preceding execution of a debuggable program according to embodiments of the present invention from the perspective of a compiler.

FIG. 4 sets forth a flow chart illustrating a further exemplary method for software development with information describing preceding execution of a debuggable program according to embodiments of the present invention from the perspective of the debugger.

FIG. 5 sets forth a flow chart illustrating a further exemplary method for software development with information describing preceding execution of a debuggable program according to embodiments.

FIG. 6 sets forth a block diagram of automated computing machinery forming a system that supports software development with information describing preceding execution of a debuggable program according to embodiments of the present invention.

FIG. 7 sets forth a flow chart illustrating a further exemplary method for software development with information describing preceding execution of a debuggable program according to embodiments of the present invention.

FIG. 8 sets forth a flow chart illustrating a further exemplary method for software development with information describing preceding execution of a debuggable program according to embodiments of the present invention.

FIG. 9 sets forth a flow chart illustrating a further exemplary method for software development with information describing preceding execution of a debuggable program according to embodiments of the present invention.

FIG. 10 sets forth a flow chart illustrating a further exemplary method for software development with information describing preceding execution of a debuggable program according to embodiments of the present invention.

FIG. 11 sets forth a flow chart illustrating a further exemplary method for software development with information describing preceding execution of a debuggable program according to embodiments of the present invention.

### DETAILED DESCRIPTION OF EXEMPLARY EMBODIMENTS

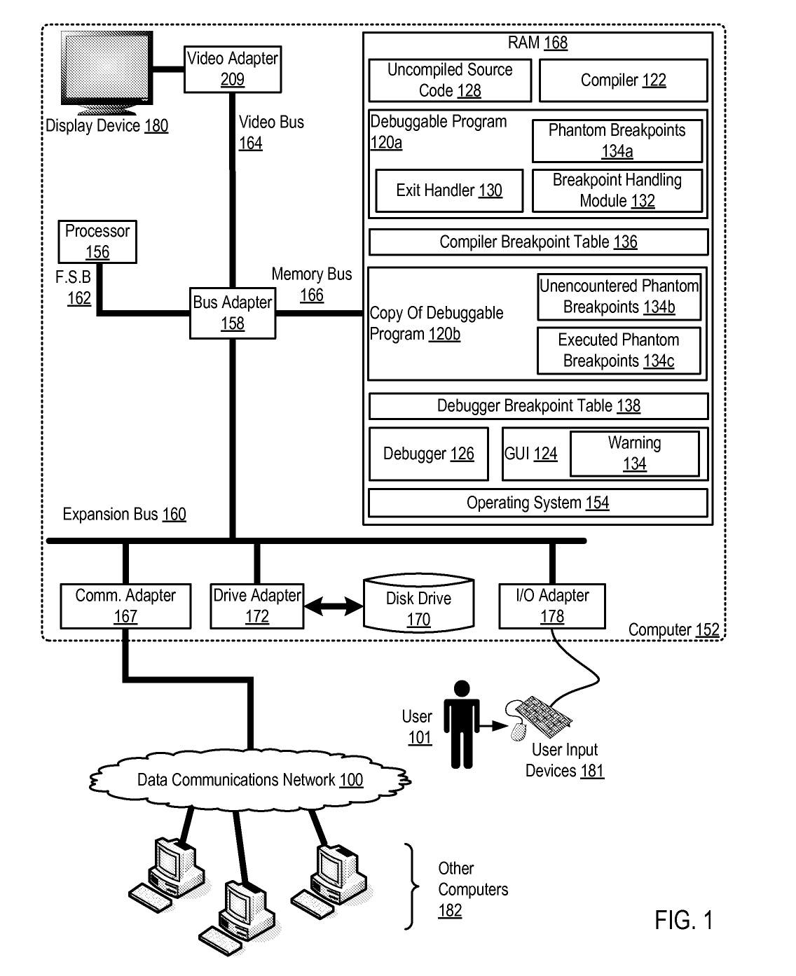

Exemplary methods, apparatus, and products for software development with information describing preceding execution of a debuggable program in accordance with the present invention are described with reference to the accompanying drawings, beginning with FIG. 1. FIG. 1 sets forth a block diagram of automated computing machinery forming a system that supports such software development according to embodiments of the present invention. The system of FIG. 1 includes an exemplary computer (152) that, in turn, includes at least one computer processor (156) or ‘CPU’ as well as random access memory (168) (RAM') which is connected through a high speed memory bus (166) and bus adapter (158) to processor (156) and to other components of the computer (152).

Stored in RAM (168) is a debugger (126). A debugger (126) is an application that controls operation of another application—a debuggee, or ‘a debuggable program’ (120a, 120b)—for the purpose of testing execution of the debuggee. The source code of the debuggee may run on an instruction set simulator (ISS), a technique that allows great power in its ability to halt when specific conditions are encountered but which will typically be somewhat slower than executing the code directly on a processor for which the code is written. When execution of a program crashes or reaches a preset condition, a debugger typically displays the position in the source code at which the execution of the program crashed. A ‘crash’ occurs when the program cannot normally continue because of a programming bug. In addition to displaying a position in source code when execution of the source code crashes, debuggers also often offer other functions such as running a program step by step (single-stepping or program animation), stopping, breaking, or pausing the program to examine the current state, at some event or specified instruction by means of a breakpoint, and tracking the values of some variables.

In the example system of FIG. 1, the debugger (126) presents a graphical user interface (124) as a front-end of the debugger (126). Front-ends are extensions to debugger engines that provide Integrated Development Environment (‘IDE’) integration, program animation, and visualization features, rather than console-based command line interfaces. The ‘front-end’ directly faces a client—or user—in contrast to the debugger (126) in the example of FIG. 1, which interfaces indirectly with the clients through the GUI (124).

Also stored in RAM (168) is a compiler (122). A compiler is a module of computer program instructions that transforms source code written in a programming language (the source language) into another computer language (the target language, often having a binary form known as object code). The most common transformation of source code creates an executable program. The compiler (122) of FIG. 1 is also configured to generate a debuggable program (120a)—the debuggee.

In the example of FIG. 1, the compiler (122) and the debugger (126) support software development with information describing preceding execution of a debuggable program in accordance with embodiments of the present invention. The compiler (122) operates for software development by inserting, while compiling source code (128) into a debuggable program (120a), a phantom breakpoint (134a) at one or more lines of source code. In some embodiments, the compiler (122) inserts a phantom breakpoint at every line of source code while in other embodiments, a user may specify the one or more lines of source code at which to insert a phantom breakpoint. A breakpoint is one or more predefined instructions inserted into debuggee source code that, when executed, cause debuggee execution to pause or stop. The breakpoint instructions typically replace or ‘overlay’ original source code instructions. Original source code in most cases comprises original machine instructions rather than higher level programming languages. In some embodiments, a breakpoint is implemented as a particular operational code, ‘opcode,’ that when executed is trapped and handled by a particular module. In other embodiments, a breakpoint may be implemented by a code that results in an error or causes an interrupt. In this specification, a breakpoint is described as a ‘phantom’ when a compiler inserts the breakpoint and when a user is relatively unaware of the existence of the breakpoint, the insertion of the breakpoint, and the handling of the breakpoint when encountered during execution.

The example compiler (122) of FIG. 1 also supports software development with information describing preceding execution of a debuggable program by including in the debuggable program (120a) a breakpoint handling module (132) and an exit handler (130). A breakpoint handling module (132) is a module of computer program instructions configured to administer phantom breakpoint encounters during execution of the debuggable program. Including such a module in a debuggable program may be carried out ways, such as, for example, including in an executable package forming the debuggable program, one or more dynamically linked libraries that include routines forming the breakpoint handling module and inserting into the source code linking instructions for the DLLs.

An exit handler is a module of computer program instructions that runs upon completion of a program's execution. Including an exit handler in the debuggable program may be carried out in various ways including, for example, including one or more DLLs that include routines forming the exit handler and inserting in the debuggable program instructions to register the exit handler with the operating system. Once registered, the exit handler will be executed at the behest of the operating system upon the debuggable program exiting by, for example, calling the system-level “exit( )” function in a Unix™-style operating system environment.

The compiler (122) may insert the phantom breakpoints (134) by replacing, at one or more lines of source code, original source code with a phantom breakpoint, storing the original source code, and generating a breakpoint table (136). The compiler breakpoint table (136) includes an entry for each phantom breakpoint inserted in the source code. Each entry in the compiler breakpoint table (136) references the original source code replaced by the phantom breakpoint. That is, each entry includes a pointer to a memory location at which the original source code is stored.

The example compiler (122) of FIG. 1 also supports software development with information describing preceding execution of a debuggable program by executing the debuggable program (120a). During execution, one or more of the phantom breakpoints are encountered and the breakpoint handling module (132) removes each encountered phantom breakpoint. The breakpoint handling module (132) may remove the encountered phantom breakpoints by replacing the encountered phantom breakpoint with original source code through use of the compiler breakpoint table (136).

The exit handler (130), upon exiting execution of the debuggable program (120a), creates a copy of the debuggable program that includes only phantom breakpoints not encountered during execution. In operation, only a portion of the debuggable program (120a) may be copied into RAM (168) during and for execution while a complete version of the debuggable program (120a) may be stored on a disk drive (170). The exit handler (130) may be configured to compare the portion of the debuggable program (120a) in RAM (168) with the version of the debuggable program (120a) in disk drive (170) to insure that any encounters of phantom breakpoints in the portion in RAM (168) is captured in the created copy (120b).

The compiler (122) may then provide the copy (120b) of the debuggable program to the debugger (126). Upon receipt, the debugger (126) may execute the copy (120b) of the debuggable program. During the execution, one or more breakpoints may be encountered. A breakpoint encountered during execution under debugger control may be a phantom breakpoint inserted by the compiler (122) at compile time but not encountered during a previous execution of the debuggable program or may be a user-specified breakpoint added during debugger control. Upon each encounter of a breakpoint, the debugger (126) in the example of FIG. 1 determines whether the encountered breakpoint is a phantom breakpoint. If the encountered breakpoint is a phantom breakpoint the debugger issues a warning (134) indicating a point of straying execution. The phrase ‘straying execution’ refers to a difference in execution under debugger control of the debuggable program and a previous execution of the debuggable program. During the previous execution any encountered phantom breakpoint was removed. If, later, during execution under debugger control a phantom breakpoint remaining in the debuggable program is encountered, the previous and present execution cannot match—the present execution has strayed from the previous execution. The warning (134) issued by the debugger (126) may be implemented in a variety of ways—as an audible warning, a visual warning, an icon in the GUI (124), a text description of the straying execution, and so on as will occur to readers of skill in the art.

Also stored in RAM (168) is an operating system (154). Operating systems that support software development with information describing preceding execution of a debuggable program according to embodiments of the present invention include UNIX™ Linux™ Microsoft XP™, AIX™ IBM's i5/OS™ and others as will occur to those of skill in the art. The operating system (154), debugger (126), compiler (122), GUI (124), and debuggee (120) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers that support software development with information describing preceding execution of a debuggable program according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers that support software development with information describing preceding execution of a debuggable program according to embodiments of the present invention include modems for wired dial-up communications, Ethernet (IEEE 802.3) adapters for wired data communications network communications, and 802.11 adapters for wireless data communications network communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

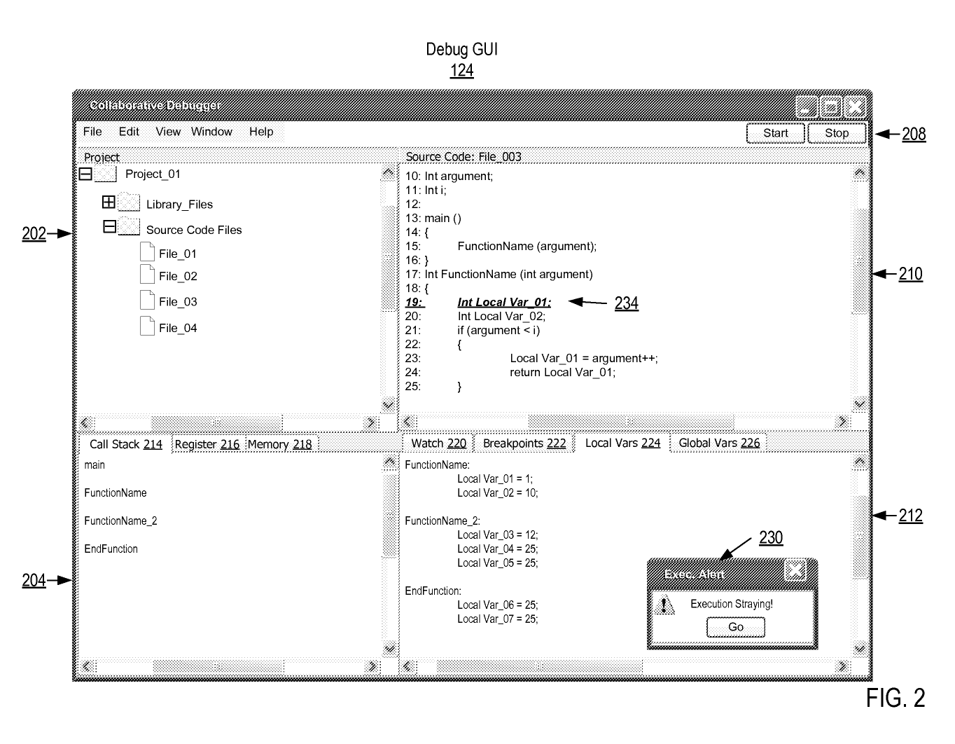

For further explanation, FIG. 2 sets forth an example GUI (124) presented to a user by a debugger in accordance with embodiments of the present invention. The example GUI (124) of FIG. 2 provides an interface for a user to control operation of a debugger and thereby a debuggee. The debugger presenting the example GUI (124) of FIG. 2 is configured for software development with information describing preceding execution of a debuggable program in accordance with embodiments of the present invention.

The example GUI (124) of FIG. 2 includes a menu bar (208) that, in turn, includes a number of separate menus: a File menu, an Edit menu, a View menu, and a Help menu. The example GUI (124) of FIG. 2 also includes several independent portions—called panes (as in ‘window panes’) for clarity of explanation—a project pane (202), a source code pane (210), and two separate data panes (204, 212). Project pane (202) presents the files and resources available in a particular software development project. Source code pane (210) presents the source code of the multi-threaded debuggee. The data panes (204, 212) present various data useful in debugging the source code. In the example of FIG. 2, data pane (204) includes three tabs, each of which presents different data: a call stack tab (214), a register tab (214), and a memory tab (218) tab. Data pane (212) includes four tabs: a watch list tab (220), a breakpoints (222) tab, a local variable tab (224), and a global variable tab (226).

The example GUI (124) of FIG. 2 sets forth various warnings issued by the debugger indicating a point of straying execution relative to one or more previous executions of the debuggable program. Readers of skill in the art will recognize that in many embodiments only one indication will be displayed at a time.

The debugger presenting the example GUI (124) of FIG. 2 displays a warning (230) of straying execution upon determining that execution of the debuggable program under debugger control program encountered a phantom breakpoint—a phantom breakpoint not encountered during a previous execution outside debugger control. The example warning (230) of straying execution is implemented as a pop-up dialog box titled “Exec. Alert,” including a warning symbol and text that reads, “Execution Straying!” The example warning (230) implemented as a pop-up dialog box also includes a GUI button with text reading “Go.” This GUI button, when invoked, may change the perspective (the display) of the GUI to present one or more source code lines at which execution begins to stray—the source code line at which the executing debuggable program encountered the phantom breakpoint.

The example GUI (124) of FIG. 2 also includes another warning (234) of non-matching execution at line 19 of the source code displayed in the source code pane (219). The warning (234) is implemented as underlined, italicized, and bolded text. The warning (234) may also be implemented with a predefined text color, such as red. The warning (234) identifies a particular line of source code at which execution of the debuggable program under debugger control strays relative to the previous execution of the debuggable program outside debugger control—the line of source at which the executing debuggable program encountered a phantom breakpoint.

Readers of skill in the art will recognize that these example warnings (230, 234) depicted in the example GUI (124) of FIG. 2 are for clarity of explanation only, not limitation. Many other forms of straying execution warnings may be implemented in GUIs that support software development in accordance with embodiments of the present invention. Pop-up dialog boxes, text notifications, audio notifications, fonts, text styles, icons, images, and so on are all other example implementations of straying execution warnings and each such example is well within the scope of the present invention.

The GUI items, menus, window panes, tabs, and so on depicted in the example client-specific GUI (124) of FIG. 2, are for explanation, not for limitation. Other GUI items, menu bar menus, drop-down menus, list-boxes, window panes, tabs, and so on as will occur to readers of skill in the art may be included in GUIs presented by debuggers configured for software development with information describing preceding execution of a debuggable program in accordance with embodiments of the present invention.

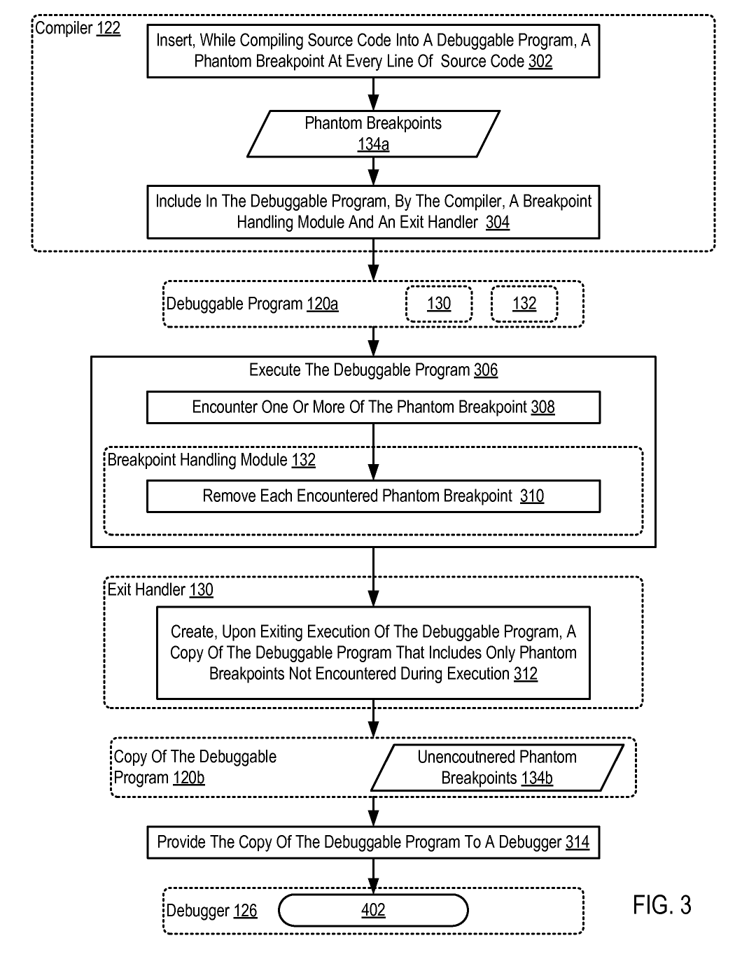

For further explanation, FIG. 3 sets forth a flow chart illustrating an exemplary method for software development with information describing preceding execution of a debuggable program according to embodiments of the present invention from the perspective of a compiler. To that end, the method of FIG. 3 includes inserting (302), by a compiler (122) while compiling source code into a debuggable program (120a), a phantom breakpoint (134a) at one or more lines of source code.

The method of FIG. 3 continues by the compiler (122) including (304) in the debuggable program (120a) a breakpoint handling module (132) and an exit handler (130). Including (304) in the debuggable program (120a) a breakpoint handling module (132) and an exit handler (130) may be carried out in various ways such as, for example, including in an executable package forming the debuggable program—a .exe file for example—one or more dynamically linked libraries that include routines forming the breakpoint handling module and inserting linking instructions for the DLLs into the source code. When the debuggable program is executed, the linking instructions are executed and the DLLs are loaded for use by the debuggable program.

The method of FIG. 3 also includes executing (306) the debuggable program. Executing (306) the debuggable program may be carried out in various ways, including, for example, by a system level fork( ) call in a Unix™-style operating system environment. In the example of FIG. 3, executing (306) the debuggable program includes encountering (308) one or more of the phantom breakpoints (134a) and removing (310), by the breakpoint handling module (132), each encountered phantom breakpoint.

The method of FIG. 3 also includes creating (312), by the exit handler, upon exiting execution of the debuggable program, a copy (120b) of the debuggable program that includes only phantom breakpoints not encountered during execution. Creating (312) a copy (120b) of the debuggable program that includes only phantom breakpoints not encountered during execution may be carried out by examining a portion of the debuggable program in memory and the debuggable program (120a) on disk, identifying any lines of source code from which phantom breakpoints have been removed in memory but not from the disk, and generating the copy of the debuggable program so as to insure that the identified lines will not include phantom breakpoints in the copy and that all other lines having phantom breakpoints removed during execution also do not include phantom breakpoints in the copy. In the example of FIG. 3, the phantom breakpoints in the copy (120b) of the debuggable program are referred to as unencountered phantom breakpoints (134b) having not been encountered during the execution (306) outside debugger control.

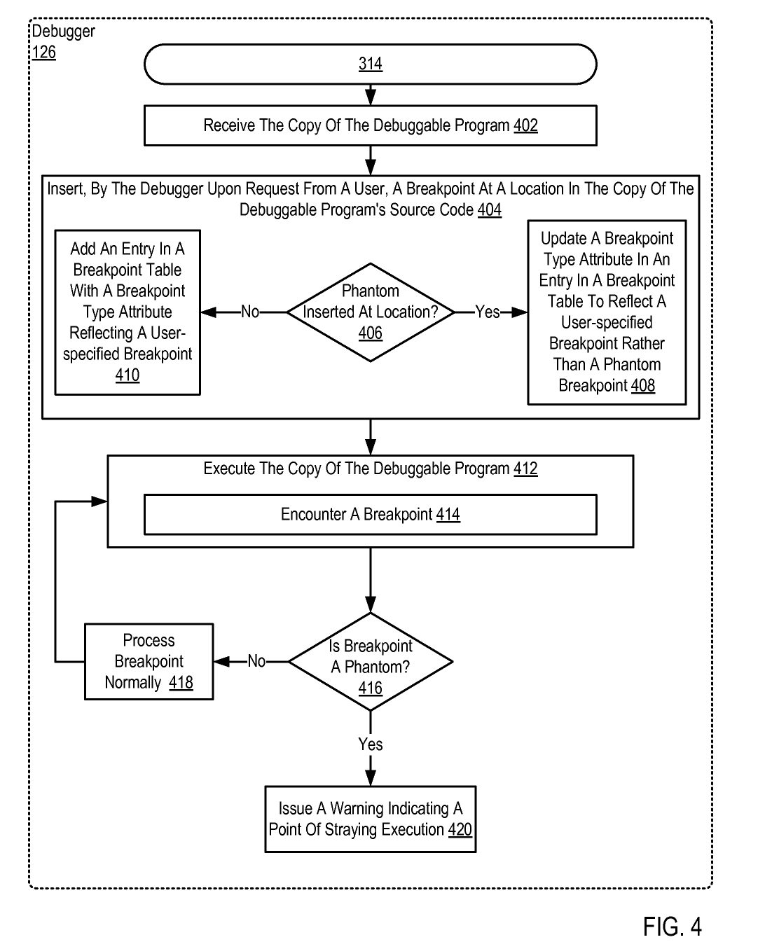

The method of FIG. 3 continues by providing (314) the copy (120b) of the debuggable program to a debugger (126). In some embodiments providing the copy (120b) of the debuggable program also includes providing a compiler breakpoint table that lists only those phantom breakpoints remaining in the copy (120b). Providing the copy (120b) of the debuggable program to the debugger (126) may be carried out in various ways. The compiler may provide the copy (120b) through an application programming interface (API) exposed by the debugger for use by the compiler, by storing the copy (120b) in computer memory, by notifying the debugger of the copy's (120b) location in memory and so on as will occur to readers of skill in the art. After providing (314) the copy of the debuggable program to the debugger, the method of FIG. 3 continues to FIG. 4, step (402).

As mentioned above, FIG. 3 sets for a method of software development from the perspective of the compiler. For further explanation, FIG. 4 sets forth a flow chart illustrating a further exemplary method for software development with information describing preceding execution of a debuggable program according to embodiments of the present invention from the perspective of the debugger.

The method of FIG. 4 continues from the method of FIG. 3, after the compiler (122) provides (314) the copy of the debuggable program to the debugger (126). The method of FIG. 4 includes receiving (402) the copy (120b) of the debuggable program. Receiving (402) the copy (120b) of the debuggable program may be carried out by loading the debuggable program's source files, executing a process for the debuggable program, calling a system-level call such a ptrace ( ) in Unix to attach the debugger to the process, and so on as will occur to readers of skill in the art.

The method of FIG. 4 also includes inserting (404), by the debugger upon request from a user, a breakpoint at a location in the copy of the debuggable program's source code. In the method of FIG. 4, inserting (404) a breakpoint at a location in the copy of the debuggable program's source code includes determining (406) whether a phantom breakpoint is inserted at the location. Determining (406) whether a phantom breakpoint is inserted at the location may be carried out by searching a breakpoint table for an entry associated with the location. If an entry associated with the location exists in the breakpoint table, a breakpoint has already been established at that location. The breakpoint, however, may be any type of breakpoint—user-specified or a phantom breakpoint. To determine the type of the breakpoint at that location, the debugger may examine a field in the entry of the breakpoint table that includes an attribute specifying the type of the breakpoint. If a phantom breakpoint is inserted at the location, the debugger in the example of FIG. 4 updates (408) the breakpoint type attribute in the entry in the breakpoint table to reflect a user-specified breakpoint rather than a phantom breakpoint. That is, the debugger changes the type of the breakpoint from phantom to user-specific in the breakpoint table, without replacing the breakpoint opcode already inserted in the source code at that location. If a phantom breakpoint is not inserted at the location, no other breakpoint is inserted at that point and the debugger in the example of FIG. 4 adds (410) an entry in the breakpoint table with a breakpoint type attribute reflecting a user-specified breakpoint.

The method of FIG. 4 continues by executing (412), by the debugger, the copy of the debuggable program. In the example of FIG. 4, executing (412) the copy of the debuggable program includes encountering (414) a breakpoint.

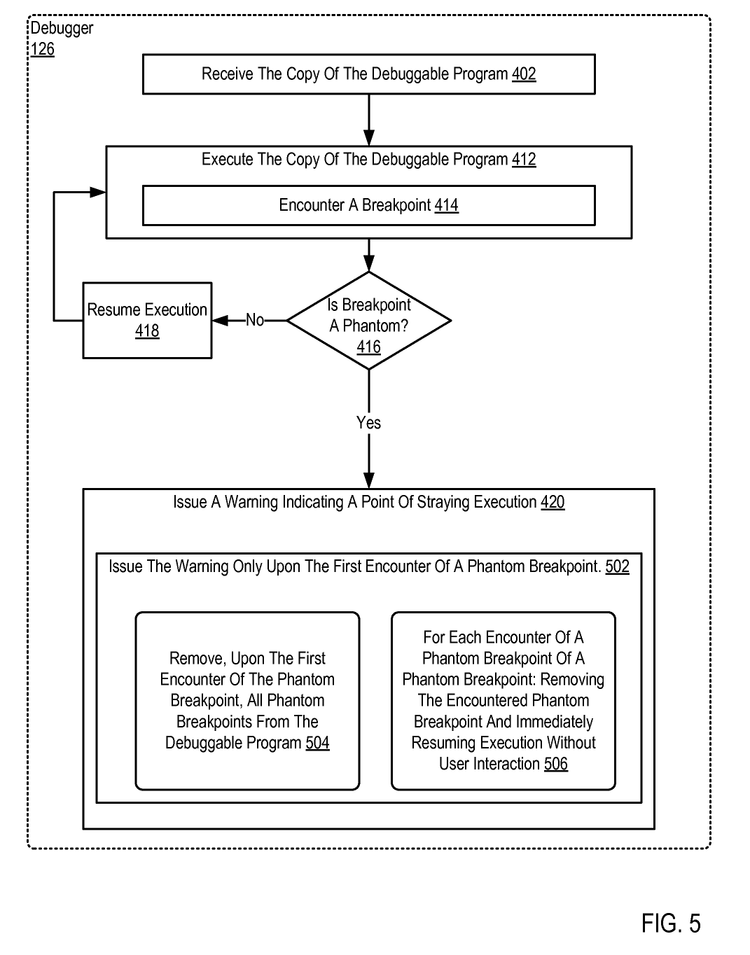

Upon each encounter of a breakpoint, the method of FIG. 4 includes determining (416), by the debugger (126), whether the encountered breakpoint is a phantom breakpoint. Again, the debugger (126) may examine the breakpoint type attribute of the entry associated with the encountered breakpoint in the breakpoint table to determine whether the breakpoint is a phantom breakpoint. If the encountered breakpoint is not a phantom breakpoint, the debugger (126) processes (418) the breakpoint normally—providing information related to the breakpoint, the call stack, variable values, and so on. If the encountered breakpoint is a phantom breakpoint, the debugger (126) issues (420) a warning indicating a point of straying execution. The debugger (126) in the example of FIG. 4 may be configured to issue a warning of straying execution upon each encounter of a phantom breakpoint or, as explained below in FIG. 5, only upon the first encounter of a phantom breakpoint. The debugger may issue (420) a warning indicating a point of straying execution in a variety of ways, several of which are described above with respect to FIG. 2.

A debugger configured for software development in accordance with embodiments of the present invention may be configured to operate in a variety of ways after a straying execution warning is issued. For example, a debugger may require express authorization from a user to continue debugging, a debugger may collect information describing debuggable program execution subsequent to the encounter of the phantom breakpoint, the debugger may remove all other phantom breakpoints prior to resuming execution, the debugger may create a copy of the debuggable program at its current execution point (the encounter of the phantom breakpoint) for historical information and fork another copy for subsequent execution, and so on as will occur to readers of skill in the art.

For further explanation, FIG. 5 sets forth a flow chart illustrating a further exemplary method for software development with information describing preceding execution of a debuggable program according to embodiments. The method of FIG. 5 is similar to the method of FIG. 4 in that the method of FIG. 5 also includes receiving (402) a copy of a debuggable program, executing (412) the copy of the debuggable program, determining (416), upon each encounter of a breakpoint, whether the encountered breakpoint is a phantom breakpoint; and, if the encountered breakpoint is a phantom breakpoint, issuing (420), by the debugger, a warning indicating a point of straying execution.

The method of FIG. 5 differs from the method of FIG. 4, however, in that the method of FIG. 5 issuing (420) a warning includes issuing (502) the warning only upon the first encounter of a phantom breakpoint. In many implementations, once execution of the debuggable program under debugger control strays relative to a previous execution outside of debugger control, many more lines of code not encountered in that previous execution may be encountered under debugger control. In embodiments in which the debugger issues a warning for each encountered phantom breakpoint, an overwhelming number of warnings may be issued. In the method of FIG. 5, however, once a first warning is issued, no further warnings are issued. Issuing (502) the warning only upon the first encounter of a phantom breakpoint may be carried out in various ways, two of which are depicted in the example of FIG. 5. One way of issuing (502) the warning only upon the first encounter of a phantom breakpoint depicted in the example of FIG. 5 includes removing (504), upon the first encounter of the phantom breakpoint, all phantom breakpoints from the debuggable program. Here, execution of the debuggable program stops upon encountering the phantom breakpoint. Then, after the debugger (126) determines the breakpoint is a phantom breakpoint and prior to resuming execution of the debuggable program, the debugger (126) issues the warning and removes all phantom breakpoints Removing all phantom breakpoints may be carried out by identifying in the breakpoint table all entries relating to phantom breakpoints (having a breakpoint type attribute that reflects a phantom breakpoint) and, for each entry, replacing breakpoint opcodes with original program source code.

The method of FIG. 5 depicts an alternative to processing the entire debuggable program to remove all phantom breakpoints prior to resuming execution after the first encounter of a phantom breakpoint. The alternative method of issuing (502) the warning only upon the first encounter of a phantom breakpoint in the example of FIG. 5 includes removing (506), for each encounter of a phantom breakpoint, the encountered phantom breakpoint and immediately resuming execution without user interaction. In this way, the debugger may quickly process (remove) a single phantom breakpoint upon each encounter of a phantom breakpoint, resuming execution so quickly that from the user's perspective, no stop occurred.

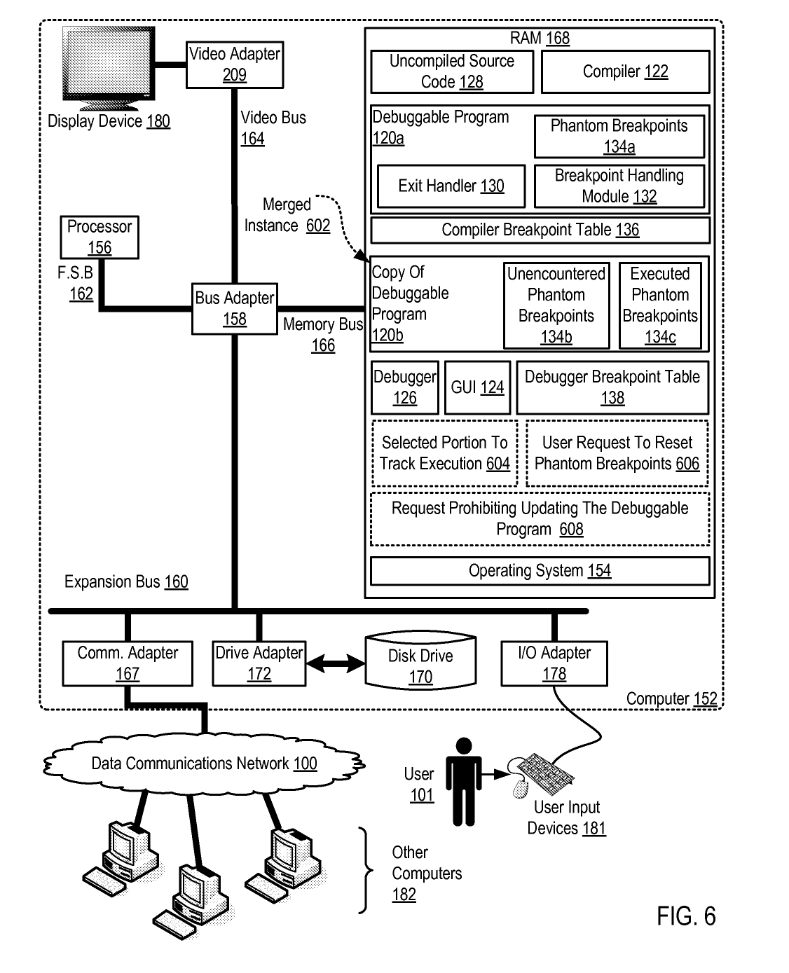

Described above of are some aspects of software development with information describing preceding execution of a debuggable program in accordance with embodiments of the present invention. Other aspects of such software development are described here, beginning with FIG. 6. FIG. 6 sets forth a block diagram of automated computing machinery forming a system that supports software development with information describing preceding execution of a debuggable program according to embodiments of the present invention. The system of FIG. 6 is similar to the system of FIG. 1 in that the system of FIG. 6 includes an exemplary computer (152) that, in turn, includes at least one computer processor (156) or ‘CPU’ as well as random access memory (168) (RAM') which is connected through a high speed memory bus (166) and bus adapter (158) to processor (156) and to other components of the computer (152).

Stored in RAM (168) of FIG. 6 is a compiler (122). The compiler (122) operates as described above to insert, into the debuggable program, a phantom breakpoint (134a) at one or more lines of source code (128); include in the debuggable program (120a) a breakpoint handling module (132) and an exit handler (130). The breakpoint handling module (132) is configured to removing each encountered phantom breakpoint during execution and the exit handler (130) is configured to update the debuggable program, upon exiting execution, to include only phantom breakpoints not encountered during the execution. In some embodiments, the updating the debuggable program includes creating a copy (120b) of the debuggable program.

Once the compiler (122) compiles the source code (128) into a debuggable program (120a), the compiler—or some other application not shown in the example of FIG. 6—may execute the debuggable program one or more times outside of debugger (126) control. For each execution: the debuggable program encounters one or more of the phantom breakpoints, the breakpoint handling module (132), removes each encountered phantom breakpoint and resumes execution, and the exit handler (130) updates the debuggable program upon exiting execution to include only phantom breakpoints not encountered during the execution.

The system of FIG. 6 also supports management of the phantom breakpoints after the one or more executions of the debuggable program. Such management may be implemented in a variety of ways by a variety of modules or applications. In some embodiments, for example, managing the phantom breakpoints of the debuggable program may include resetting, after the one or more executions, responsive to a user request (606), each phantom breakpoint of the debuggable program inserted at compile time by the compiler and removed during the one or more executions. That is, after some number of executions, some phantom breakpoints being removed, a user may request that all phantom breakpoints be re-inserted as originally inserted by the compiler at compile time. The debugger (126), compiler (122), or some other module of computer program instructions may receiving and execute such a request.

In other embodiments, multiple instances of the debuggable program (120a) may be created and executed. That is, rather than a single instance being executed one or more times, several separate instances may be executed one or more times. Executions of separate instance may vary. That is, phantom breakpoints may be encountered in an execution of one instance, but not in an execution of another instance. In such an embodiments, managing the phantom breakpoints of the debuggable program may include merging the instances of the debuggable program into a merged instance of the debuggable program, the merged instance (602) including only phantom breakpoints not encountered during any execution of any instance of the debuggable program.

In other embodiments, management of phantom breakpoints may be carried out primarily by the debugger (126). To that end, the debugger (126) in the example of FIG. 6 may be configured to load the copy (120b) of the debuggable program and manage phantom breakpoints by: receiving, from a user (101), a selection (604) of a portion of the debuggable program's source code to track execution and executing the debuggable program under debugger control, including removing only phantom breakpoints encountered within the selected portion (604) of the debuggable program's source code.

In other embodiments, after loading the copy (120b) of the debuggable program, the debugger may manage phantom breakpoints by receiving, from a user (101), a request (608) prohibiting updating the debuggable program to include only phantom breakpoints not encountered during execution under debugger control, disabling the exit handler (130) of the debuggable program, and exiting execution under debugger control without updating phantom breakpoints in the debuggable program. That is, the copy of the debuggable program (120b) loaded by the debugger may—and in most cases will—include the exit handler (130) originally compiled into the debuggable program by the compiler. Exiting execution normally under debugger control would, without disabling the exit handler, cause the exit handler (130) to update the debuggable program. During debug control, however, a user may desire to keep the source files unaltered. As such, the debugger (126) may manage the phantom breakpoints in a way to preserve the original phantom breakpoints, even if one or more phantom breakpoints were encountered during execution under debugger control.

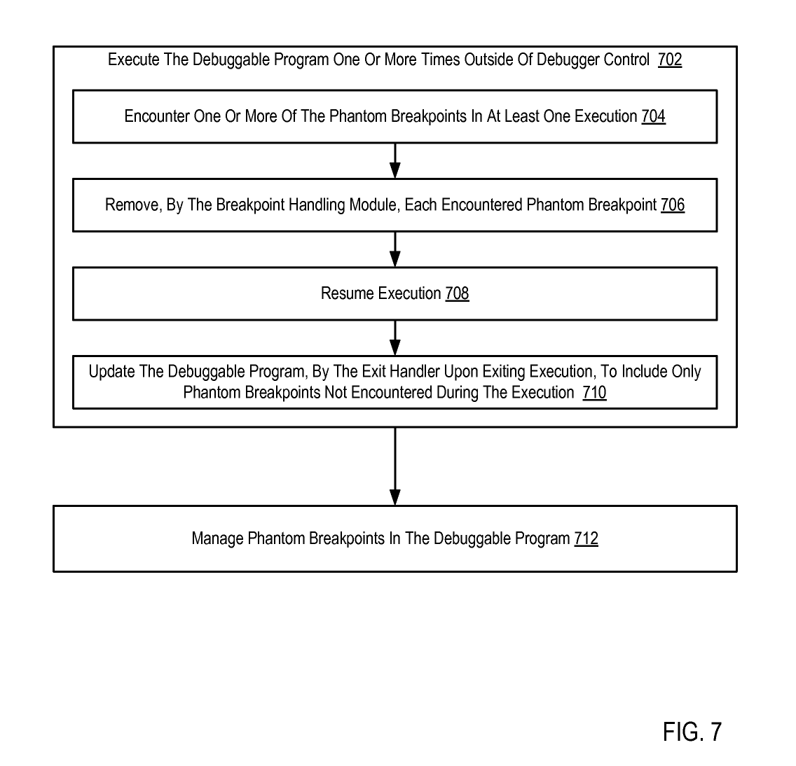

For further explanation, FIG. 7 sets forth a flow chart illustrating a further exemplary method for software development with information describing preceding execution of a debuggable program according to embodiments of the present invention. The debuggable program in the method of FIG. 7 includes a breakpoint handling module, an exit handler, and one or more phantom breakpoints inserted at compile time by a compiler, each phantom breakpoint inserted at a separate line of source code of the debuggable program.

The method of FIG. 7 includes executing (702) the debuggable program one or more times outside of debugger control. In the method of FIG. 7, executing (702) the debuggable program one or more times outside of debugger control includes: encountering (704), in at least one execution, one or more of the phantom breakpoints, and for each execution: removing (706), by the breakpoint handling module, each encountered phantom breakpoint, resuming (708) execution, and updating (710) the debuggable program, by the exit handler upon exiting execution, to include only phantom breakpoints not encountered during the execution.

Updating (710) the debuggable program, by the exit handler upon exiting execution, to include only phantom breakpoints not encountered during the execution may be carried out by creating a copy of the debuggable program as described above with respect to FIGS. 1, 3, and 6. In some embodiments, however, the exit handler need not create a new copy, but may instead update the executable file from which the debuggable program is executing. When executed, instructions forming the debuggable program are copied from an executable file on disk or other lower-level data storage into computer memory—such as RAM, or other higher-level memory. Upon exiting execution then, the exit handler may examine the instructions in computer memory and make any changes with respect to phantom breakpoints in the executable file on disk—without ever creating a copy of the executable file.

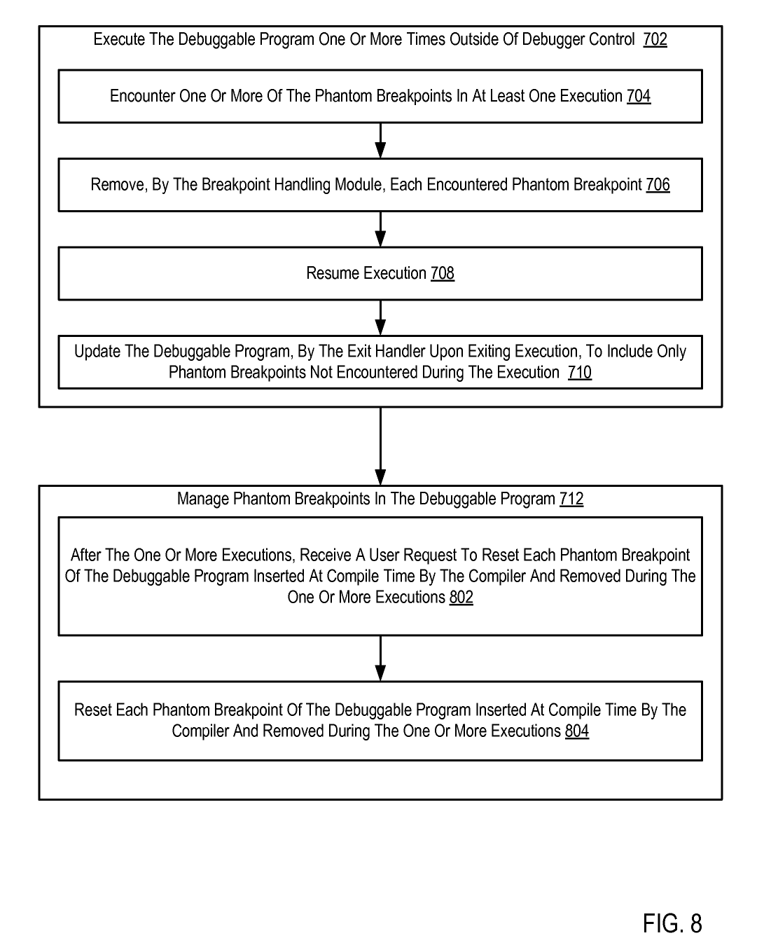

The method of FIG. 7 also includes managing (712) phantom breakpoints in the debuggable program. As mentioned above managing (712) phantom breakpoints in the debuggable program may be carried out in a variety of ways by a variety of modules. To that end, FIGS. 8-11 set forth various examples methods of managing (712) phantom breakpoints in the debuggable program.

For further explanation, FIG. 8 sets forth a flow chart illustrating a further exemplary method for software development with information describing preceding execution of a debuggable program according to embodiments of the present invention. The method of FIG. 8 is similar to the method of FIG. 7 in that the method of FIG. 8 includes executing (702) the debuggable program one or more times outside of debugger control and managing (712) phantom breakpoints in the debuggable program.

The method of FIG. 8 differs from the method of FIG. 7, however, in that in the method of FIG. 8, managing (712) phantom breakpoints in the debuggable program is carried out by receiving (802), after the one or more executions of the debuggable program, a user request to reset each phantom breakpoint of the debuggable program inserted at compile time by the compiler and removed during the executions. A compiler, a debugger, or other application module may receive and execute such a request. A user may provide a request through interaction with one or more GUI objects designated for such a purpose, by entering a command in a command line interface, by setting an attribute in metadata describing the executable file of the debuggable program followed by execution of the executable file, and so on as will occur to readers of skill in the art.

Responsive to the user request, the method of FIG. 8 continues by resetting (804) each phantom breakpoint of the debuggable program inserted at compile time by the compiler and removed during the one or more executions. Resetting (804) phantom breakpoints may be carried out be comparing an original breakpoint table created by the compiler to a breakpoint table for the debuggable program that reflects the current state of phantom breakpoints in the debuggable program, identifying, in dependence upon the comparison, locations in source from which phantom breakpoints were removed, and re-inserting phantom breakpoints at locations from which phantom breakpoints were removed.

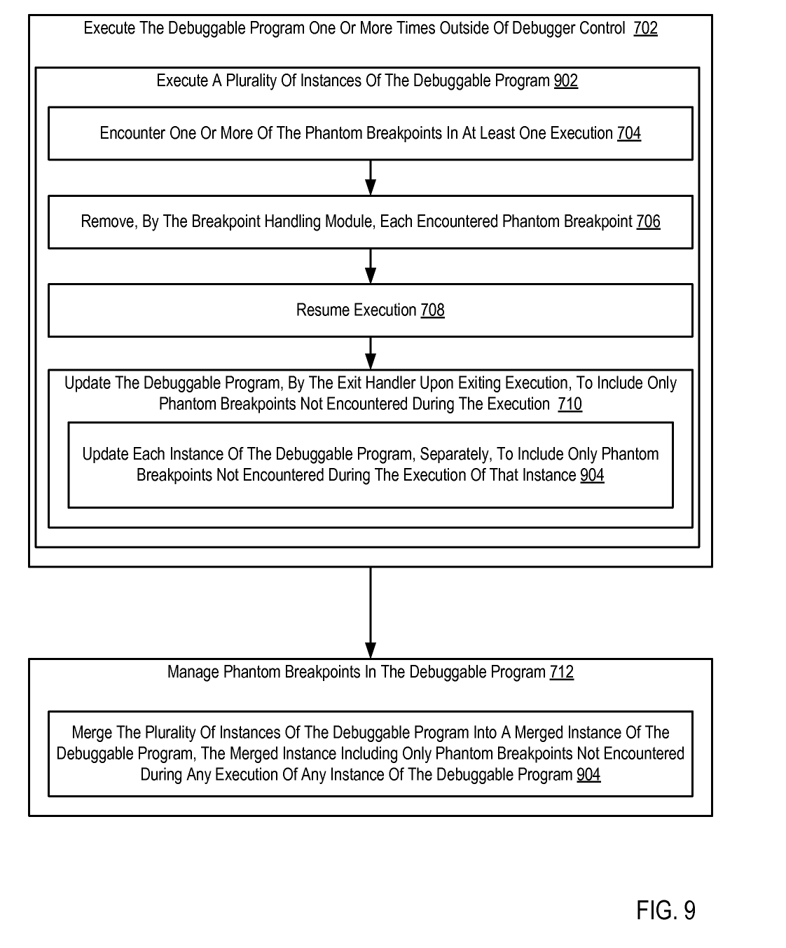

For further explanation, FIG. 9 sets forth a flow chart illustrating a further exemplary method for software development with information describing preceding execution of a debuggable program according to embodiments of the present invention. The method of FIG. 9 is similar to the method of FIG. 7 in that the method of FIG. 9 includes executing (702) the debuggable program one or more times outside of debugger control and managing (712) phantom breakpoints in the debuggable program.

The method of FIG. 9 differs from the method of FIG. 7, however, in that in the method of FIG. 9 executing (702) the debuggable program includes executing a number of instances of the debuggable program (902) and updating (710 the debuggable program to include only phantom breakpoints not encountered during the execution includes updating (710) each instance of the debuggable program, separately, to include only phantom breakpoints not encountered during the execution of that instance. In the method of FIG. 9 as each instance exits, a separate instance of the debuggable program is updated. This may occur for various reasons, but one example reason may be peer testing. Consider an environment in which a software development desires real-world test results—‘beta testing’—of the debuggable program. In such an example, each tester may be provided a separate instance of the debuggable program and each tester may execute that separate instance any number of times. If no tester reports an error, crash, or the like, the software developer may make some inferences regarding the portions of code executed by the testers. Specifically, the software developer may infer that no significant errors exist in the executed portions of code. Determining which portions were actually executed among all instances, however, may be difficult when multiple instances of the debuggable program—say ten thousand—exist.

To that end, managing (712) phantom breakpoints in the debuggable program includes merging the instances of the debuggable program into a merged instance of the debuggable program. Such merging may be carried out by the compiler, the debugger, or some other module. The module carrying out merging (904) is referred to here as the ‘merging module.’ In the method of FIG. 9, the merged instance includes only phantom breakpoints not encountered during any execution of any instance of the debuggable program. Merging instances of debuggable programs may be carried out by identifying, from each instance's breakpoint table, locations in source code form which phantom breakpoints were removed, and removing phantom breakpoints from those locations in an original version of the compiled debuggable program. That is, merging module may be provided with a copy of the debuggable program that includes all phantom breakpoints originally inserted by the compiler and may remove phantom breakpoints from that copy based on each instance's breakpoint table.

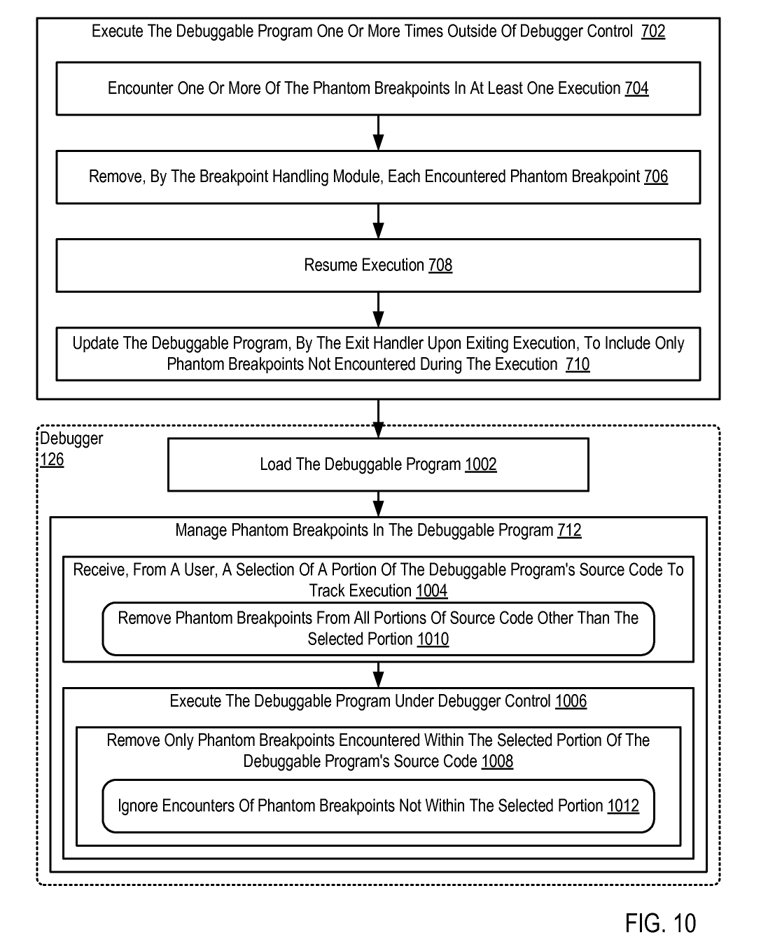

For further explanation, FIG. 10 sets forth a flow chart illustrating a further exemplary method for software development with information describing preceding execution of a debuggable program according to embodiments of the present invention. The method of FIG. 10 is similar to the method of FIG. 7 in that the method of FIG. 10 includes executing (702) the debuggable program one or more times outside of debugger control and managing (712) phantom breakpoints in the debuggable program.

The method of FIG. 10 differs from the method of FIG. 7, however, in that the method of FIG. 10 includes loading (1002), by a debugger (126), the debuggable program and managing (712) phantom breakpoints in the debuggable program includes: receiving (1004), from a user, a selection of a portion of the debuggable program's source code to track execution and executing (1006) the debuggable program under debugger control, removing (1008) only phantom breakpoints encountered within the selected portion of the debuggable program's source code. The example of FIG. 10 depicts two alternative methods to effect removing (1008) only phantom breakpoints encountered within the selection portion of the debuggable program's source code. In one method, the debugger (126), responsive to receiving the selected portion and prior to executing (1006) the debuggable program under debugger control, removes (1010) phantom breakpoints from all portions of source code other than the selected portion. In this way, the only phantom breakpoints that may be encountered during execution are those within the selection portion of the debuggable program's source code. Locations of the removed phantom breakpoints not within the selected portion may be stored and the exit handler, upon an exit, may re-insert phantom breakpoints at the stored locations.

In an alternative method, the debugger (126) may be configured to ignore (1012) encounters of phantom breakpoints not within the selected portion. The debugger (126) may ignore (1012) encounters of phantom breakpoints not within the selected portion in various ways including, for example, by, upon each breakpoint encounter, determining from a breakpoint table whether the breakpoint is a phantom breakpoint, if the breakpoint is a phantom breakpoint and the location of the encounter is not within the selected portion, resuming execution immediately without user interaction.

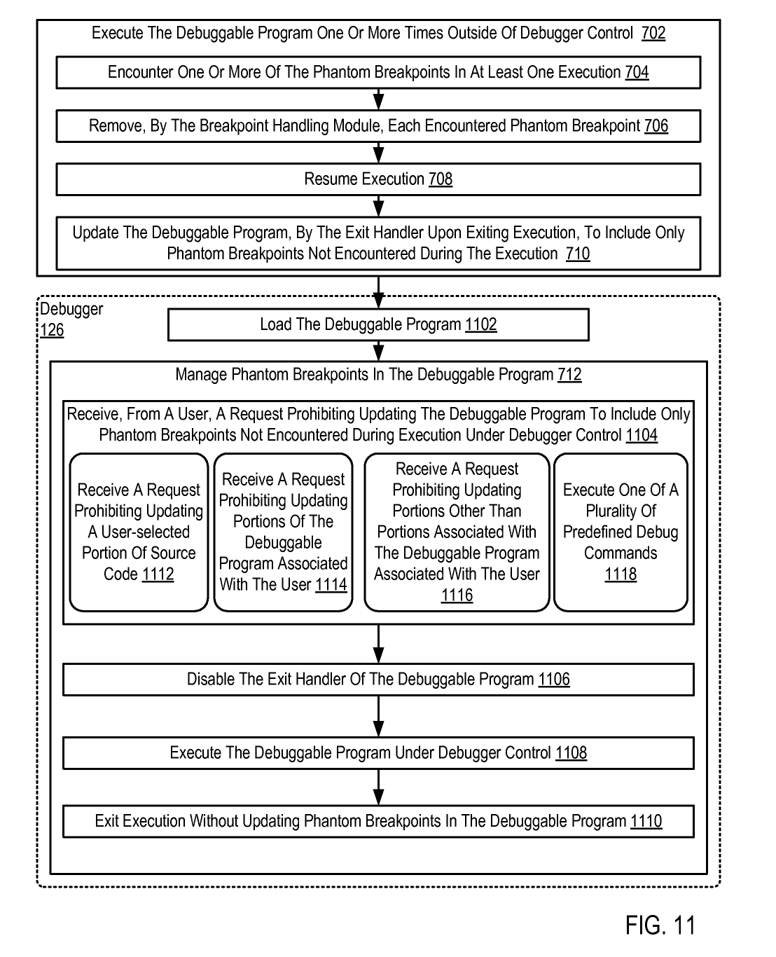

For further explanation, FIG. 11 sets forth a flow chart illustrating a further exemplary method for software development with information describing preceding execution of a debuggable program according to embodiments of the present invention. The method of FIG. 11 is similar to the method of FIG. 7 in that the method of FIG. 11 includes executing (702) the debuggable program one or more times outside of debugger control and managing (712) phantom breakpoints in the debuggable program.

The method of FIG. 11 differs from the method of FIG. 7 in that the method of FIG. 11 includes loading (1102), by a debugger (126), the debuggable program and managing (712) phantom breakpoints in the debuggable program includes: receiving (1104), from a user, a request prohibiting updating the debuggable program to include only phantom breakpoints not encountered during execution under debugger control; disabling (1106), by the debugger, the exit handler of the debuggable program; and exiting (1110) execution under debugger control without updating one or more phantom breakpoints in the debuggable program in accordance with the request In the example of FIG. 11, receiving (1104) a request to prohibit updating the debuggable program may be implemented in a variety of ways. For example, receiving (1104) the request may include receiving a general prohibition from updating any and all phantom breakpoints in the debuggable program. With such a request, the debugger will completely disable the exit handler, possibly replacing the exit handler with another, and exit execution without updating any phantom breakpoint the debuggable program.

In another embodiment, receiving (1104) a request to prohibit updating the debuggable program includes receiving (1112) a request prohibiting updating a user-selected portion of source code. Here a user may specify a function, one or more source code lines, a module and the like for which phantom breakpoints will remain even if encountered when execution exits. In such an embodiment, the debugger (126) may disable the exit handler with respect to those user-selected portions such that upon exiting (1110) execution, no phantom breakpoints in the user-selected portion of the debuggable program are updated.

In another embodiment, receiving (1104) a request to prohibit updating the debuggable program includes receiving (1114) a request prohibiting updating portions of the debuggable program associated with the user. Portions of the debuggable program associated with the user may be those portions ‘owned’ by the user—originally developed by the user, most recently modified by the user, and so on. Rather than an a user specifying portions of the debuggable program as above, the debugger may identify those portions associated with the user, disable (1108) the exit handler relative to those portions, and exit (1110) without updating phantom breakpoints in portions the debuggable program associated with the user.

Alternatively, receiving (1104) a request to prohibit updating the debuggable program may include receiving (1118) a request prohibiting updating portions other than portions associated with the debuggable program associated with the user. While in the previous embodiment, a user prohibits updating portions associated with the user, here the user prohibits updating portions not associated with the user. In this way, the user's execution need not affect other user's portions of the debuggable program.

In other embodiments, receiving (1104) a request to prohibit updating the debuggable program includes executing (1118) one of a plurality of predefined debug commands. A debug command is a command carried out by the debugger. Examples of such commands include step, step over, start, stop, insert breakpoint, insert watchpoint, insert catchpoint, evaluate expression, and so on. Some command, such as goto and reverse execution, may cause the path of execution of the debuggable program to be effectively untraceable. As such, when such commands are executed, the debugger (126) may be configured to disable (1106) the exit handler and exit (1110) execution without updating any phantom breakpoints (or only those encountered prior to the command) in the debuggable program.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable transmission medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable transmission medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable transmission medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of software development with information describing preceding execution of a debuggable program, the method comprising:
receiving, by a debugger from a compiler, a copy of a debuggable program, the debuggable program comprising one or more phantom breakpoints not encountered during a previous execution of the debuggable program, each phantom breakpoint inserted at a separate line of source code, wherein phantom breakpoints encountered in a previous execution of the debuggable program were removed during the previous execution and not included in the copy of the debuggable program;
executing, by the debugger, the copy of the debuggable program;
upon each encounter of a breakpoint, determining, by the debugger, whether the encountered breakpoint comprises a phantom breakpoint; and
if the encountered breakpoint is a phantom breakpoint, issuing, by the debugger, a warning indicating a point of straying execution.

2. The method of claim 1 further comprising:
inserting, by the debugger upon request from a user, a breakpoint at a location in the copy of the debuggable program's source code including:
determining whether a phantom breakpoint is inserted at the location; and if a phantom breakpoint is inserted at the location, updating a breakpoint type attribute in an entry in a breakpoint table to reflect a user-specified breakpoint rather than a phantom breakpoint.

3. The method of claim 1 wherein issuing a warning indicating a point of straying execution further comprises issuing the warning only upon the first encounter of a phantom breakpoint.

4. The method of claim 3 wherein issuing the warning only upon the first encounter of a phantom breakpoint further comprises removing, upon the first encounter of the phantom breakpoint, all phantom breakpoints from the debuggable program.

5. The method of claim 3 wherein issuing the warning only upon the first encounter of a phantom breakpoint further comprises:
for each encounter of a phantom breakpoint: removing the encountered phantom breakpoint and immediately resuming execution without user interaction.

6. The method of claim 1 further comprising:
inserting, by the compiler while compiling source code into the debuggable program, a phantom breakpoint at one or more lines of source code;
including in the debuggable program, by the compiler, the breakpoint handling module and the exit handler;
executing the debuggable program including encountering one or more of the phantom breakpoints and removing, by the breakpoint handling module, each encountered phantom breakpoint;
creating, by the exit handler, upon exiting execution of the debuggable program, the copy of the debuggable program that includes only phantom breakpoints not encountered during execution; and
providing the copy of the debuggable program to the debugger.

7. An apparatus for software development with information describing preceding execution of a debuggable program, the apparatus comprising a computer processor, a computer memory operatively coupled to the computer processor, the computer memory having disposed within it computer program instructions that, when executed by the computer processor, cause the apparatus to carry out the steps of:
receiving, by a debugger from a compiler, a copy of a debuggable program, the debuggable program comprising one or more phantom breakpoints not encountered during a previous execution of the debuggable program, each phantom breakpoint inserted at a separate line of source code, wherein phantom breakpoints encountered in a previous execution of the debuggable program were removed during the previous execution and not included in the copy of the debuggable program;
executing, by the debugger, the copy of the debuggable program;
upon each encounter of a breakpoint, determining, by the debugger, whether the encountered breakpoint comprises a phantom breakpoint; and
if the encountered breakpoint is a phantom breakpoint, issuing, by the debugger, a warning indicating a point of straying execution.

8. A computer program product for software development with information describing preceding execution of a debuggable program, the computer program product disposed upon a computer readable medium, the computer program product comprising computer program instructions that, when executed, cause a computer to carry out the steps of:
receiving, by a debugger from a compiler, a copy of a debuggable program, the debuggable program comprising one or more phantom breakpoints not encountered during a previous execution of the debuggable program, each phantom breakpoint inserted at a separate line of source code, wherein phantom breakpoints encountered in a previous execution of the debuggable program were removed during the previous execution and not included in the copy of the debuggable program;
executing, by the debugger, the copy of the debuggable program;
upon each encounter of a breakpoint, determining, by the debugger, whether the encountered breakpoint comprises a phantom breakpoint; and
if the encountered breakpoint is a phantom breakpoint, issuing, by the debugger, a warning indicating a point of straying execution.

9. The computer program product of claim 8 wherein the computer readable medium comprises a storage medium.

10. The computer program product of claim 8 wherein the computer readable medium comprises a transmission medium.

11. A method of software development with information describing preceding execution of a debuggable program, the debuggable program comprising a breakpoint handling module, an exit handler, and one or more phantom breakpoints inserted at compile time by a compiler, each phantom breakpoint inserted at a separate line of source code of the debuggable program, the method comprising:
executing the debuggable program one or more times outside of debugger control, including: encountering, in at least one execution, one or more of the phantom breakpoints, and for each execution: removing, by the breakpoint handling module, each encountered phantom breakpoint, resuming execution, and updating the debuggable program, by the exit handler upon exiting execution, to include only phantom breakpoints not encountered during the execution; and
managing phantom breakpoints in the debuggable program.

12. The method of claim 11 wherein managing phantom breakpoints in the debuggable program further comprises: after the one or more executions of the debuggable program, resetting, responsive to a user request, each phantom breakpoint of the debuggable program inserted at compile time by the compiler and removed during the one or more executions.

13. The method of claim 11 wherein:
executing the debuggable program one or more times further comprises:
executing a plurality of instances of the debuggable program;
updating each instance of the debuggable program, separately, to include only phantom breakpoints not encountered during the execution of that instance; and
managing phantom breakpoints in the debuggable program further comprises merging the plurality of instances of the debuggable program into a merged instance of the debuggable program, the merged instance including only phantom breakpoints not encountered during any execution of any instance of the debuggable program.

14. The method of claim 11 further comprising loading, by a debugger, the debuggable program, wherein managing phantom breakpoints in the debuggable program further comprises:
receiving, by the debugger from a user, a selection of a portion of the debuggable program's source code to track execution; and
executing the debuggable program under debugger control, including removing only phantom breakpoints encountered within the selected portion of the debuggable program's source code.

15. The method of claim 14 wherein receiving, by the debugger from a user, a selection of a portion of the debuggable program's source code to track execution further comprises removing, responsive to receiving the selected portion, phantom breakpoints from all portions of source code other than the selected portion.

16. The method of claim 14 wherein removing only phantom breakpoints encountered within the selected portion of the debuggable program's source code further comprises ignoring encounters of phantom breakpoints not within the selected portion.

17. The method of claim 11 further comprising loading, by a debugger, the debuggable program, wherein managing phantom breakpoints in the debuggable program further comprises:
receiving, by the debugger from a user, a request prohibiting updating the debuggable program to include only phantom breakpoints not encountered during execution under debugger control;
disabling, by the debugger, the exit handler of the debuggable program; and
exiting execution under debugger control without updating one or more phantom breakpoints in the debuggable program in accordance with the request.

18. The method of claim 17 wherein receiving the request prohibiting updating the debuggable program further comprises one of:
receiving a request prohibiting updating a user-selected portion of source code;
receiving a request prohibiting updating portions of the debuggable program associated with the user;
receiving a request prohibiting updating portions other than portions associated with the debuggable program associated with the user; or
executing one of a plurality of predefined debug commands.

19. An apparatus for software development with information describing preceding execution of a debuggable program, the debuggable program comprising a breakpoint handling module, an exit handler, and one or more phantom breakpoints inserted at compile time by a compiler, each phantom breakpoint inserted at a separate line of source code of the debuggable program, the apparatus comprising a computer processor, a computer memory operatively coupled to the computer processor, the computer memory having disposed within it computer program instructions that, when executed by the computer processor, cause the apparatus to carry out the steps of:
executing the debuggable program one or more times outside of debugger control, including: encountering, in at least one execution, one or more of the phantom breakpoints, and for each execution: removing, by the breakpoint handling module, each encountered phantom breakpoint, resuming execution, and updating the debuggable program, by the exit handler upon exiting execution, to include only phantom breakpoints not encountered during the execution; and
managing phantom breakpoints in the debuggable program.

20. A computer program product for software development with information describing preceding execution of a debuggable program, the debuggable program comprising a breakpoint handling module, an exit handler, and one or more phantom breakpoints inserted at compile time by a compiler, each phantom breakpoint inserted at a separate line of source code of the debuggable program, the computer program product disposed upon a computer readable storage medium, the computer program product comprising computer program instructions that, when executed, cause a computer to carry out the steps of:
executing the debuggable program one or more times outside of debugger control, including: encountering, in at least one execution, one or more of the phantom breakpoints, and for each execution: removing, by the breakpoint handling module, each encountered phantom breakpoint, resuming execution, and updating the debuggable program, by the exit handler upon exiting execution, to include only phantom breakpoints not encountered during the execution; and
managing phantom breakpoints in the debuggable program.
